(19) United States
(12) Patent Application Publication
(10) Pub. No.: US 2021/0280339 A1
(43) Pub. Date: Sep. 9, 2021

(54) ARMOURED POWER CABLE

(71) Applicant: PRYSMIAN S.P.A., Milano (IT)

(72) Inventors: Paolo MAIOLI, Milano (IT); Rodolfo SICA, Milano (IT)

(21) Appl. No.: 17/163,223

(22) Filed: Jan. 29, 2021

(30) Foreign Application Priority Data
Jan. 31, 2020 (IT) 102020000001915

(51) Int. Cl. H01B 7/22; H01B 7/18; H01B 9/00

(52) U.S. Cl. CPC H01B 7/226; H01B 9/00; H01B 7/1875

(57) ABSTRACT

An armoured power cable is disclosed. The cable includes: at least one core comprising an electric conductor; and an armour surrounding the core, wherein the amour comprises at least one layer made of a metallic material having a tensile strength of at least 400 MPa and showing a weight loss from 0.01% to 0.1% after 30 days of exposure to a corrosive solution according to ASTM G3172 (2004). The cable has mechanical properties suitable for its handling and installation, for example, underwater, and its armour can be at least partially degraded over time after installation due to corrosion exerted by corrosive agents present in the installation environment, without impairing the mechanical properties of the other cable portions and without impairing its electric performance.

### BACKGROUND

### Technical Field

The present disclosure generally relates to the field of electric cables, i.e., cables for electric power transmission.

In particular, the present disclosure relates to an armoured cable.

### Description of the Related Art

Armoured cables are well-known in the art and are generally employed in applications where mechanical stresses and potential damages are envisaged.

For example, cables for submarine applications have to sustain high tensile loads during installation and operation. In fact, when a submarine cable hangs off of the installation vessel from the surface of the water to the seabed for 200 meters or more, an undesirable tensile stress could be exerted on the conductors, thus an armour is provided to bear such stress.

In addition, the payoff system of the installation vessel has to be suitable for the weight of the cable to be deployed. The heavier the cable is, the stronger the gripping force of the payoff system needs to be. As the gripping force increases, the compression resistance of the cable also has to increase. Crush failure caused by gripping is a known failure mode.

The cable core is surrounded by an armour in the form of one or more layers of stranded wires. The armour is a structural reinforcing part having the function of strengthening the mechanical characteristics and performance of the cable during handling and installation thereof, while maintaining a suitable flexibility, as well as the function of providing resistance against external damage. The use of metal in the armour is particularly advisable in submarine cables due to the compressive forces potentially exerted thereon, which may be a problem for non-metallic armours.

Typically, the armour is made of one or two layers of wires, round or flat in shape, made of steel with low to medium carbon content, for example, ranging from less than 0.015% to up to 2%. Steel, generally galvanized, e.g., zinc coated steel, is typically used due to its low cost, availability of supply and good mechanical properties. Other materials used for the cable armour can be copper, brass, or bronze. Galvanized steel is preferably used when the armour wires are exposed to the environment without any polymeric sheath or yarn layer, to ensure better resistance to corrosion.

However, the armour as above has the disadvantage of increasing the overall weight of the cable. This not only makes it difficult to handle and install the cable but also makes it very difficult to recover the cable from a seabed, for example, in case of maintenance or for replacing no longer operating cable portions.

It should be noted that the mechanical reinforcement provided by the armour is required during handling and installation of the cable but may be not necessary or may be required to a lesser extent after the cable has been installed and during its operating life. This is the case, for instance, when the cable is installed in shallow water sea as it will be subjected to one or more of a lower compressive force, or in restricted areas such as marine wind farms where the risk that the cable is damaged by impact with an external object, for example, a boat anchor, is relatively low.

Thus, there is the need to provide an armoured cable having adequate resistance to mechanical stresses during handling and installation and that is also designed in such a way to allow an easier recovery of the cable from the installation site, e.g., seabed, for example, in case of maintenance, so as to replace no longer operating cable portions.

### BRIEF SUMMARY

The present disclosure relates to an armoured cable wherein the armour has a predetermined corrosion profile over time in the environment where it is installed. Such a cable can be used, for instance, for submarine applications, in particular for operation underwater in shallow water sea. The Applicant found that the above need can be met by providing the cable with an armour made of a metallic material having suitable mechanical properties to mechanically strengthen the cable and, at the same time, having the ability to deteriorate over time, in the environment where the cable is installed.

In particular, the Applicant has experienced that a cable armour made of certain materials prone to be at least one of chemically or electrochemically decomposed by corrosive agents present in the environment where the cable is installed and operates, e.g., sea water, allows an armoured cable having resistance to mechanical stresses adequate to guarantee the integrity of the cable during handling and installation to be obtained, while the armour is able to at least partially deteriorate by corrosion over time during the operating life of the cable, according to a predetermined corrosion profile.

As a result, after installation and during its operating life, the cable armour progressively “weakens” to some extent by the corrosive agent present in its operating environment over time. The environmental corrosion causes the armour to get lighter and impair the armour structural integrity to an extent such that when the armour is subjected to forces, e.g., pulling forces for recovering the cable from the seabed, it falls apart and detaches from the cable core.

Thus, in case a maintenance of the cable is needed (due, for example, to a malfunction or current interruption), the recovery of the cable for their replacement in correspondence with cable portions no longer operating can be carried out in an easier manner.

The above benefits are achieved without adversely affecting the integrity and performance of the cable during its operation life as the cable structure can normally withstand the mechanical stresses at the installation site even when the armour layer has been impaired due to the corrosion.

Accordingly, the present disclosure relates to an armoured power cable comprising:
at least one core comprising an electric conductor; and
an armour surrounding the core, wherein the armour comprises at least one layer made of a metallic material having a tensile strength of at least 400 MPa and a weight loss from 0.01% to 0.1% after 30 days of exposure to a corrosive solution according to ASTM G3172 (2004).

In an embodiment, the metallic material of the armour has a tensile strength of 800 MPa at most.

In an embodiment, the metallic material of the armour has an elongation at break of at least 10%.

In an embodiment, the metallic material of the armour has an elongation at break of 25% at most, for example, of 20% at most.

In an embodiment, the metallic material of the armour has a weight loss from 0.01 from % to 0.05% after 30 days of exposure to a corrosive solution according to ASTM G3172 (2004)

In an embodiment, the armour layer(s) comprises/comprise elongated tensile elements helically wound around the core.

In an embodiment, the metallic material forming the armour layer(s) of the cable is an aluminium alloy. In an embodiment, the aluminium alloy is an aluminium-copper alloy having, for example, a copper content in the range from about 0.5% to about 7% by weight on the total weight of the alloy.

In an embodiment, the aluminium-copper alloy is chosen among 2xxx series aluminium alloys. The 2xxx Series Alloys comprise aluminium and copper alloys, e.g., copper content ranging from 0.7 to 6.8%, with ultimate tensile strength greater than 400 MPa.

### BRIEF DESCRIPTION OF THE DRAWING

FIG. 1 shows schematically an example armoured cable according to the present disclosure.

### DETAILED DESCRIPTION

For the purpose of the present description and of the claims that follow, except where otherwise indicated, all numbers expressing amounts, quantities, percentages, and so forth, are to be understood as being modified in all instances by the term “about.” Also, all ranges include any combination of the maximum and minimum points disclosed and include any intermediate ranges therein, which may or may not be specifically enumerated therein.

As used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

It should be understood that the features of the embodiments of the disclosure disclosed above and below can be combined in any way, even forming further embodiments that are not explicitly disclosed but that fall within the scope of the present disclosure.

The cable according to the present disclosure comprises at least one cable core and an armour surrounding the cable core.

The cable can be a single-core cable or a multi-core cable adapted, for example, to 3-phases power transmission, the number of cores in the cable being not a limitation for the present disclosure. In an embodiment, the cable is a three-phase power transmission cable comprising three single-phase cores.

Such cable can be suitable in submarine applications for direct current (DC) or alternate current (AC) power transmission in the medium and high voltage ranges. In the present disclosure, the term medium voltage (MV) is used to indicate voltages of from 1 to 35 kW and the term high voltage (HV) is used to indicate voltages higher than 35 kW.

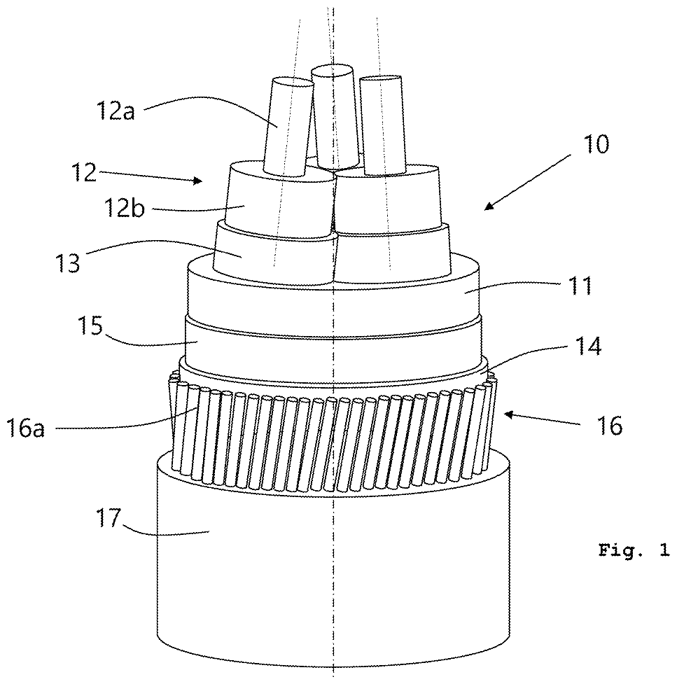

Further details will be illustrated in the following detailed description given by way of example and not of limitation, with reference to the attached FIG. 1 which shows schematically an exemplary armoured cable according to the present disclosure.

In FIG. 1, the armoured cable 10 is a power cable for submarine AC applications comprising three cores 12. Each core comprises a metal conductor 12a, for example, made of copper, aluminium or both, in the form of a rod or of stranded wires. The conductor 12a is sequentially surrounded by an inner semiconducting layer and insulating layer and an outer semiconducting layer, said three layers, collectively illustrated and referred to as insulating system 12b, being made of polymeric material, for example, cross-linked polyethylene, wrapped paper or paper and polypropylene laminate. In the case of the semiconducting layer(s), the material thereof is charged with conductive filler such as carbon black.

Each insulating system 12b is enveloped by a metal sheath 13. Besides acting as electric screen, the metal sheath can protect the insulating system against undue water ingression to maintain the dielectric strength. The metal sheath may be made of aluminium, lead, copper or other metals suitable for this purpose in a variety of shapes.

Each metal sheath can be surrounded by a polymeric buffer layer (not illustrated). The buffer layer can be made of optionally semi-conductive polyethylene, for example, high-density polyethylene (HDPE) or low-density polyethylene (LDPE), polyvinyl chloride (PVC), polyamide (Nylon) and polyurethane.

The three cores 12 are helically stranded together according to a prefixed core stranding pitch and embedded in a polymeric filler 11 surrounded, in turn, by a tape 15 and by a cushioning layer 14.

For polymeric filler 11, polypropylene yarns or raffia-like strands can be employed, for example. These materials allow filling the hollow space without adding excessive weight to the cable.

The cushioning layer 14 can be made, for example, of polypropylene yarns.

Around the cushioning layer 14 an armour 16 comprising a single layer of wires 16a is provided. The wires 16a are helically wound around the cable core 12 according to an armour winding pitch.

The wires 16a are made of a 2xxx aluminium alloy, for example, a 2024 aluminium alloy.

The 2024 aluminium alloy is an aluminium-copper alloy having the following composition:

Cu from 3.5% to 4.9%;

Mg from 1.2% to 1.8%;

Si≤0.5%;

Fe≤0.5%;

Mn from 0.3% to 0.9%;

Cr≤0.1%;

Zn≤0.25%;

Ti≤0.15%; and

other elements no more than 0.05% each and no more than 0.15% in total, the remainder being aluminium, wherein the percentages are by weight on the total weight of the composition.

The 2024 aluminium alloy can have a tensile strength of 400 MPa or more. The 2024 aluminium alloy can have an elongation at break of 10% or more.

The armour 16 can be surrounded by a protective layer 17 made, for example, of polypropylene yarns. Such a protective layer, when present, has substantially no water-blocking capacity.

As discussed above, the armour is made of a metal material having mechanical properties, for example, tensile strength, suitable to mechanically reinforce the cable during handling and installation thereof and to protect it from external damages, for example, from compressive damages. According to the present disclosure, the metal material making the cable armour is also able to deteriorate over time by the action of corrosive agents, e.g., chloride salts, present in the operating environment of the cable after its installation.

As already said, the cable armour comprises at least one layer made of a metallic material showing a weight loss from 0.01% to 0.1% after 30 days of exposure to a corrosion solution according to the specifications of ASTM G3172 (2004).

In some embodiments, it should be noted that the weight loss of the armour metal material can vary, within the given range, from one 30-days' time span to another, as will be shown in the example hereinbelow.

The environmental corrosion causes the armour, and thus the overall cable of the present disclosure, to become progressively “lighter” over time in the installation environment, e.g., sea water.

Also, the environmental corrosion can weaken the armour structural integrity to an extent such that when the armour is subjected to forces (e.g., pulling forces for recovering the cable from the seabed), it falls apart and detaches from the cable core. Where some metals, like galvanized steel, can be corroded uniformly over their surface, the prevailing degradation mechanism of, for example, aluminium alloy's fracture toughness is the formation of corrosion-induced surface cracks or pits (see, for example, N. D. Alexopoulos et al., Materials Science and Engineering A 498 (2008) 248-257). This allows the recovery of cable portions from the installation site for their replacement, for example, in case of maintenance operations, being carried out in a simpler manner. It should be noted that the protection from compression force is substantially no longer needed once the cable is deployed.

In the case of an AC cable, the corrosion of the metal armour can decrease the resistive losses connected thereto. The provision of, for example, an aluminum alloy as metallic material for the armour cable allows AC electrical power transport capability of the cable to increase compared to prior art armoured cables using ferromagnetic materials for the cable armour such as carbon steel, construction steel and ferritic stainless steel.

When alternate current (AC) is transported into the cable, the temperature of electric conductors within the cable rises due to resistive losses, a phenomenon referred to as Joule effect. In some embodiments, a cable armour made of a ferromagnetic material may provide a relevant contribution to the overall cable losses. Consequently, the performance of the cable in terms of alternate current intensity flowing into the conductor(s) or, in other words, in terms of electrical power transport capability, need to be reduced or limited to some extent in order to maintain the temperature rise due to resistive losses under a prefixed threshold that guarantees the integrity of the cable.

As aluminium alloys are non-ferromagnetic materials, the losses in the cable armour can be reduced and the electrical power transport capability of the cable consequently increased without increasing the cable size which otherwise would make the cable heavier and more expensive.

Thus, the armour weight loss experienced in a corrosive environment can further decrease the resistive losses over time.

In the case of an AC single core cable, the armour may be used as a return conductor. In such an instance, the weight loss and pit corrosion experienced over time by an armour made of a metal according to the present disclosure does not substantially impair the electric transport capability of the return current.

Also, aluminium alloys, such as 2024 aluminium alloys, are relatively inexpensive materials and thus the armoured cable according to the disclosure can be produced at reduced costs.

The Applicant conducted mechanical tests on cables specimens having the structure of the cable 10 shown in FIG. 1.

The armour of the specimens was exposed to a corrosion environment made of Mediterranean Sea water (collected in Cogoleto, GE, Italy) according to the specification of ASTM G31-72 (2004).

The sea water had an initial apparent pH of 8.09. The sea water volume per exposure area was 8 ml/cm² and the solution temperature was 25±3° C. The specimens (having a weight of about 10 g) were exposed to the sea water for a number of different exposure times.

After the exposure, the weight of the specimen was measured before and after the test. The first sample was left in the sea water for 30 days, while the second sample was left in sea water for 60 days.

The first sample showed a weight loss of about 0.07%, while the first sample showed a weight loss of about 0.08%.

The weight loss was due to the corrosion of the metal by, generally, the chloride anion in the sea water, by causing the formation of 0.18 pits/cm² in the first sample and of 0.24 pits/cm² in the second sample.

The formation and growing of pits can bring an impairment of the mechanical properties of the armour wires to such an extent that they weaken the armour wires so that, in case cable recovery is necessary, the armour wires get fractured and loose, falling apart from the cable structure.

It should be noted that the weight loss per month (30 days) can vary due, for example, to seasonal changes of the water temperature, but also due to the specific metal and to the kind and/or amount of the corrosive agents which can give place to an exponential decrease of the weight loss.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An armoured power cable comprising:
at least one core including an electric conductor; and
an armour surrounding the at least one core, wherein the armour includes at least one layer made of a metallic material having a tensile strength of at least 400 MPa and weight loss from 0.01% to 0.1% after 30 days of exposure to a corrosive solution according to ASTM G3172 (2004).

2. The armoured power cable according to claim 1, wherein the metallic material of the at least one layer of the armour has a tensile strength of 800 MPa at most.

3. The armoured power cable according to claim 1, wherein the metallic material of the at least one layer of the armour has an elongation at break of at least 10%.

4. The armoured power cable according to claim 1, wherein the metallic material of the at least one layer of the armour has an elongation at break of 25% at most.

5. The armoured power cable according to claim 1, wherein the at least one layer of the armour includes elongated tensile elements helically wound around the at least one core.

6. The armoured power cable according to claim 1, wherein the metallic material forming the at least one layer of the armour is an aluminium alloy.

7. The armoured power cable according to claim 6, wherein the aluminium alloy is an aluminium-copper alloy.

8. The armoured power cable according to claim 7, wherein the aluminium-copper alloy has a copper content in a range from about 0.5% to about 7% by weight on a total weight of the alloy.

9. The armour power cable according to claim 8, wherein the aluminium-copper alloy is a 2-xxx series aluminium alloy.

10. The armoured power cable according to claim 1, wherein the armoured power cable is a three phase power transmission cable, and the at least one core includes three single-phase cores for transporting alternate current.
